(19) United States
(12) Patent Application Publication
(10) Pub. No.: US 2013/0246109 A1
(43) Pub. Date: Sep. 19, 2013

(54) SYSTEM, ARTICLE, AND METHOD FOR ANNOTATING RESOURCE VARIATION

(71) Applicants: Jhilmil Jain, Sunnyvale, CA (US); Martha L. Lyons, Sunnyvale, CA (US); Geoffrey M. Lyon, Half Moon Bay, CA (US); Manish Marwah, Palo Alto, CA (US)

(72) Inventors: Jhilmil Jain, Sunnyvale, CA (US); Martha L. Lyons, Sunnyvale, CA (US); Geoffrey M. Lyon, Half Moon Bay, CA (US); Manish Marwah, Palo Alto, CA (US)

(21) Appl. No.: 13/988,744

(22) PCT Filed: Dec. 15, 2010
(86) PCT No.: PCT/US10/60577

§ 371 Date: May 21, 2013

(51) Int. Cl. G06Q 10/06

(52) U.S. Cl. CPC G06Q 10/0631
USPC 705/7.12

(57) ABSTRACT

A system and article are disclosed for annotating resource variation. In one example, the system discloses an installation 102, having a device 128 associated with a user 118, and a resource manager 107, 120 programmed with executable instructions, which detect a resource 104 variation 308 associated with the device 128, and label the resource variation with a user annotation 316 generated by the user. In another example, the system discloses a network resource manager service 107 programmed with executable instructions, which interface with an installation 102, having a set of sensors 126 and a set of devices 128 associated with a user 118, receive data from at least one of the sensors which detects a resource 104 variation 308 associated with at least one of the devices; and label the detected resource variation with a user annotation 316.

### CROSS-REFERENCE TO RELATED OR CO-PENDING APPLICATIONS

This application relates to co-pending U.S. patent application Ser. No. 12/860,401, entitled “Tracking Major Appliance Efficiency,” (PDNo. 201001392-RI: 82264499) filed on Aug. 20, 2010, by Marwah et al., and U.S. patent application Ser. No. 12/859,931, entitled “Disaggregating Power Consumption,” (PDNo. 201001393-RI: 82264502) filed on Aug. 20, 2010, by Marwah et al. These related applications are commonly assigned to Hewlett-Packard Development Co. of Houston, Tex.

### BACKGROUND OF THE INVENTION

### Brief Background Introduction

The present invention relates generally to systems and methods for managing resources. As competition grows throughout the world for various resources, systems and services which help set prices and ensure delivery of such resources in a predictable, reliable way are ever more necessary. Current systems and services for managing resources often contain information bottlenecks which introduce inefficiencies that unnecessarily either increase price and/or limit their availability. Further improvements in resource management are desired.

### BRIEF DESCRIPTION OF THE DRAWINGS

Some examples of the invention are described in the following figures:

FIG. 1 is one example of a system for annotating resource variation;

FIG. 2 is one example of a data structure for implementing the system;

FIG. 3 is one example of a first user interface showing data collected by the system;

FIG. 4 is one example of a second user interface showing resource usage identified by the system;

FIG. 5 is a flowchart of one example of a method for annotating resource variation; and

FIG. 6 is another example of the system for annotating resource variation.

### DETAILED DESCRIPTION

Scarcity of resources and their price are closely linked in our modern worldwide economy. Managing such resources effectively and in harmony between resource producers and resource consumers can yield significant production and consumption efficiencies that benefit both. Effective and efficient resource management, perhaps effected through a resource ecosystem or a cloud service, can help promote conservation practices and environmental sustainability. Resources in this context include not only a home or business' electric, water, and gas production, consumption, and recycling, but also can include any other resource, including: network bandwidth; use of network bandwidth; computation and storage resources available via cloud services; and so on. These resources can either be from sustainable, renewable, or non-renewable sources.

In one example embodiment of a world-wide deployment of the present invention, a cloud resource management service could monitor and maintain the resources of millions households and businesses, and millions of computing and access devices, encompassing an installed base of billions of energy consuming devices and appliances throughout the world.

some embodiments, demand response and consumer energy efficiency would drive the creation of products with appropriate hooks to enable user participation as peers within a negotiated energy-balanced ecosystem. Such embodiments have the potential to generate vast quantities of mineable data which, if managed and analyzed appropriately, would be of great benefit to consumers, device manufacturers, utility providers, and the public sector; contributing to a reduction in any nation's carbon footprint.

Additionally, a resource management service's collection of energy and resource information from billions of households would likely create an opportunity for “Resource Intelligence” brokers to provide 3rd parties (e.g. device manufacturers, utilities, and governments) a platform to analyze and deliver targeted products and services based on resource or energy-oriented analytics, performed against a massive energy intelligence repository that is collected.

To help achieve such current and future resource management goals, the present invention includes a cloud services based network resource manager and/or a local installation based resource manager, which together or individually provide mechanisms for users to detect, annotate, and understand their resource (e.g. energy) usage and/or generation in response to data obtained from a suite of installation based sensing systems. Such “installations” can be defined as an individual home, business, a political region (e.g. a city), a utility, a production line, a smart-grid, a region, a transmission line, a recycling facility, and so on, or any combination thereof. The present invention thus permits a user to associate specific user or local installation based behaviors, actions, or activities with detected resource events, anomalies, or other detected observations.

In addition, the present invention permits users to predict the resource effects of their future actions, which the resource managers then monitor and quantify actual resource effects achieved, thereby in effect collecting empirical data on many millions of local “tests” which when aggregated and analyzed can help ground-truth the plans of other resource users or product and service providers.

The present invention's use of annotation enables more resource usage and production patterns to be detected, especially given the complexity of individual home and business environments, and the ever expanding product base for consumer home entertainment and appliances, and business equipment and machinery.

Details of the present invention are now discussed.

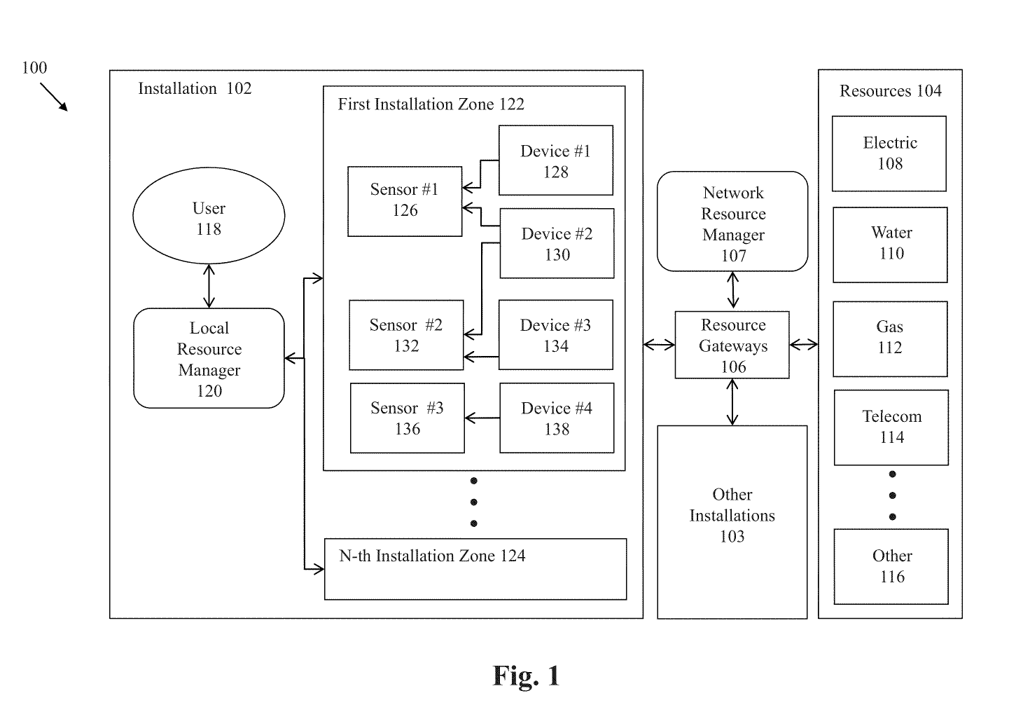

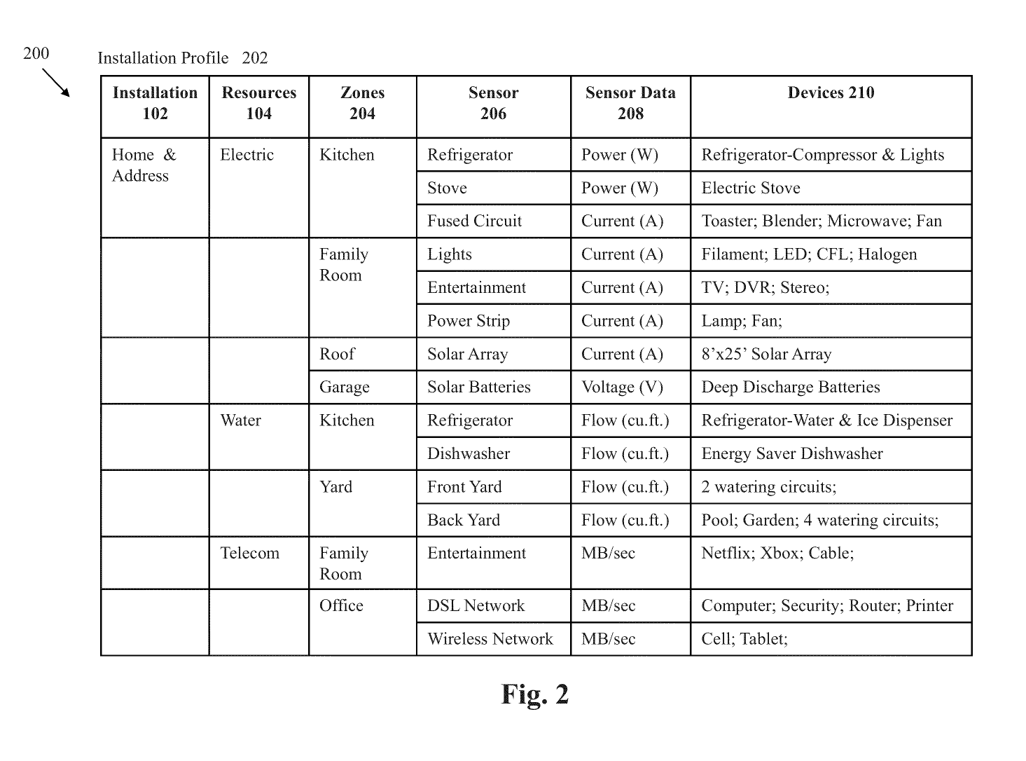

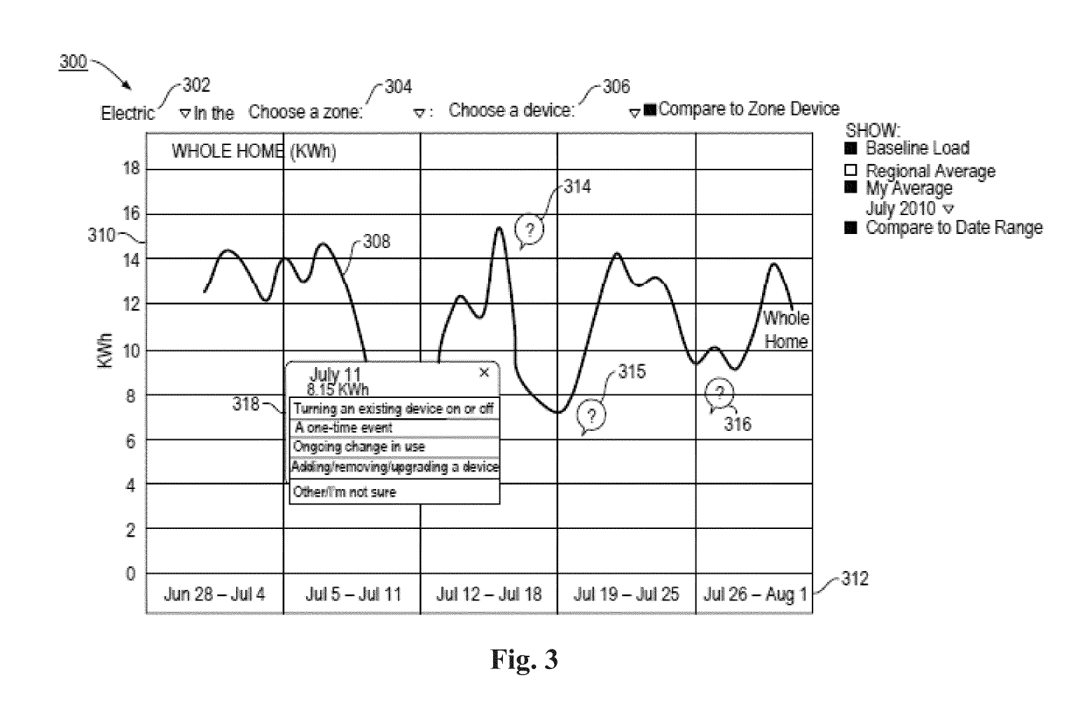

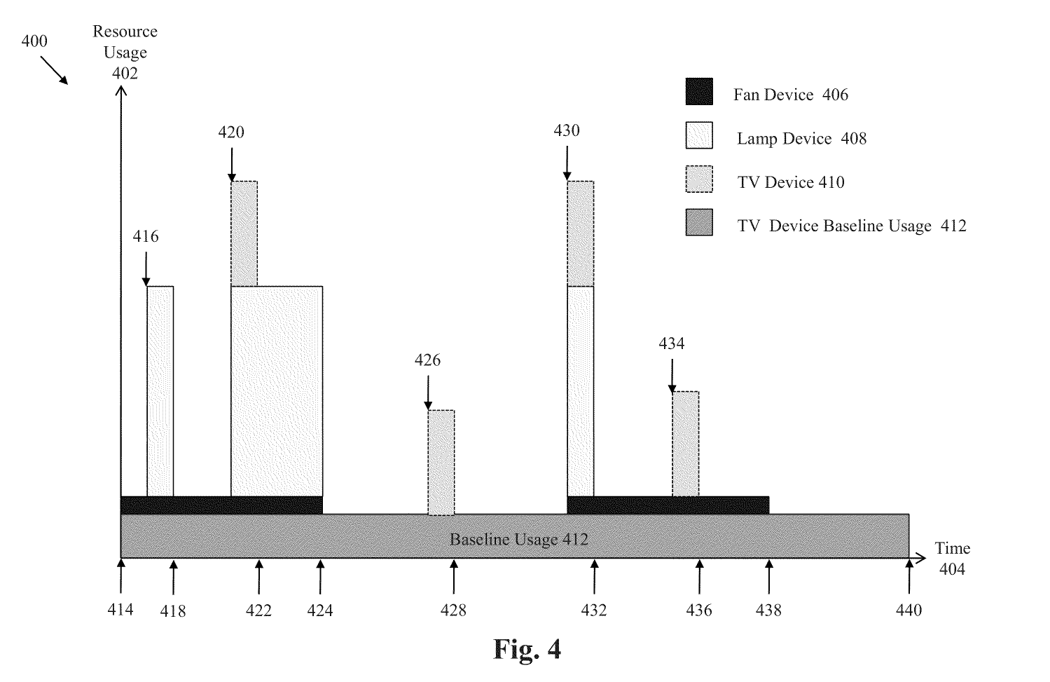

FIG. 1 is one example of a system 100 for annotating resource variations. FIG. 2 is one example of a data structure 200 for implementing the system 100. FIG. 3 is one example of a first user interface 300 showing data collected by the system 100. FIG. 4 is one example of a second user interface 400 showing resource usage identified by the system 100. Due to the integrated operation of the system 100 with the data structure 200, and the illustrative benefits of reviewing the data collected and resource usage identified by the system 100, FIGS. 1 through 4 are discussed together, when necessary, to facilitate understanding of the present invention.

The basic architecture of the system 100 includes one or more installations 102 and 103 connected to a set of resources 104 and a network resource manager 107 through a set of resource gateways 106. In this example embodiment, the resources include: electric 108, water 110, gas 112, telecommunication (Telecom) 114, and/or any other resource 116 provided to or received from one or more of the installations 102 and 103. The resource gateways 106 can include a main power cable, a water pipe, a gas pipe, a land phone-line, a wireless link, and supporting network connections for exchanging resources 104 and associated information. The network resource manager 107, in one example, is effected by a cloud-service.

The example installation 102 includes a user 118, a local resource manager 120, and a first installation zone 122 through an N-th installation zone 124. The first installation zone 122 includes a set of sensors 126, 132, and 136, connected to monitor and/or control those resources 104 used or generated by a set of devices 128, 130, 134, and 138. Note that device #2 130 (e.g. a refrigerator) is monitored both by sensor #1 126 (e.g. perhaps monitoring, the refrigerator's compressor and tight bulbs) and by sensor #2 132 (e.g. perhaps monitoring the refrigerator's water and ice dispensers). The N-th installation zone 124 includes sensors and devices as well, but which may be connected in its own unique way.

The sensors can be of any type, including: an electric sensor, a water sensor, a gas sensor, a data sensor, a network sensor, a volume sensor, a weight sensor, a temperature sensor, a chemical sensor, a biological sensor, a light sensor, and a motion sensor. Also note, that in certain embodiments, there already exists a sensor (e.g. electric meter, water meter, gas meter) connected to one or more of the resource gateways 106. Such a sensor can function as a overall sensor for the entire installation (e.g. an electric meter can also function as a “whole house” electric Current(A) sensor).

The network resource manager 107 and local resource manager 120 (a.k.a. Energy Intelligence Managers (EIM)) respectively perform remote and local monitoring and control of resources 104 consumed or generated by the devices 128, 130, 134, and 138 within the installation 102. This monitoring can logically be thought of as a resource sensing layer. This resource sensing layer can be built using a Zigbee wireless network of energy sensing nodes (e.g. sensors 126, 132, and 136) which collect information streams from a suite of Smart-Grid enabled devices. The wireless network relays the resource usage or generation data streams to the network managers 107 and 120 along with an operational consumption profile. The network managers 107 and 120 could also control device attributes or install self-implementing policies at each device.

For the network resource manager 107 and/or local resource manager 120 to know the zones, sensors, devices, and resources to be consumed or generated at each installation, an installation profile needs to be completed for the installation 102. The user 118 can complete this profile, or analytics within the resource managers 107 and 120 can automatically profile the installation 102.

FIG. 2 shows an example installation profile 202 data structure 200. In this profile 202, the installation 102 is defined as a “Home & Address”. The resources 104 monitored at this installation 102 are: electric, water, and network bandwidth. The zones 204 for monitoring electricity are: the kitchen, family room, roof, and garage. The zones 204 for monitoring water are: the kitchen, and yard. The zones 204 for monitoring network bandwidth are: the family room, and office. The sensors 206 are defined as collecting sensor data 208 for various devices 210, as shown. For example, in the family room zone 204, the lights sensor 206 is collecting Current (A) sensor data 208 from the following group of devices 210: a filament light bulb; an LED array; a CFI (compact fluorescent light; and one or more halogen lights. Other example sets of sensor data 208 and associated devices 210 are also shown in FIG. 2. The example installation profile 202 may also include an operational profile (not shown) for each device 210. The operational profile can specify whether a device is: “always on”; periodically on; occasionally on; or follows a pre-programmed daily, weekly, etc. schedule (e.g. such as possible with HVAC thermostat controllers).

The installation profile can also include other installation 102 attributes and metadata, some of which may be obtainable through public records, and social networking sites. These other attributes can include: geographic location, square footage, number of individuals therein, year built, permits for renovations, and so on.

Over time as the system 100 operates and collects data, not only from the installation 102 but also from other installations 103, the resource managers 107 and 120 often will be able to automatically identify devices at either the installation, zone, or sensor level as the system's 100 analytics learn the energy usage patterns of specific devices commonly used. Depending upon the robustness of these analytics, as few as just one sensor 206 may be used (e.g. collecting sensor data 208 from just one standard home electric-meter sensor, instead of a larger number of Smart-plug sensors located throughout the home) to identify and track multiple devices in the installation 102. The resource managers 107 and 120 may also flag possible discrepancies in the installation profile, for explanation by the user 118.

Once the installation 102 and installation profile 202 have been defined and sensor data has been collected, then analysis, annotation, and mediation of resource 104 usage and/or generation by the installation 102 can begin. The annotation and mediation functions are now discussed. The user interfaces in FIG. 3 and FIG. 4 are illustrative of the present invention's functionality, and are used to facilitate this discussion. Even though the invention will now be further discussed in the context of electrical power consumption within a home, this teaching can apply to other example embodiments involving any other installation 102 or resource 104.

The user interface 300 in FIG. 3 shows an example of an electrical resource variation over time. The user interface 300 includes a resource selection 302 pull-down menu for selecting which of the resources 104 to monitor (e.g. an “electric” resource). Another pull-down menu for zone selection 304 (e.g. “Whole Home”) corresponds to the zones 122 and 124 in FIG. 1, and zone 204 in FIG. 2. The device selection 306 initially corresponds to sensor 126, 132, 136, 206 selection, since little if any sensor data has yet been collected. However, over time as the system 100 collects more and more sensor data and annotations, the device selection 306 can correspond to specific devices 128, 130, 134, 138 or 210, since the resource managers 107 and 120 contain analytics which will separate out device resource variations within sensor resource variations in situations where one sensor is connected to multiple devices over time (see FIG. 4 for an example). Note that while FIG. 3 does not show an “installation selection”, the network resource manager 107 would be able to make such a selection. Similarly, the example in FIG. 3 does not include an “optional” device 306 selection, and instead just specifies the “Whole Home” zone.

In response to the user's 118 selections, the user interface 300 displays the selected resource data 308 on a graph having a resource usage axis 310 and a time axis 312. As can be seen from this graph, the resource data 308 varies over time. Note that while FIG. 3 shows resource data 308 indicating that electricity is being “consumed”, in alternate installations 102 the presence of a solar cell device (not shown) would “generate” electricity and shift the resource data 308 plot down toward (if not below) the time axis 312.

The resource manager 107, 120 contain a set of data analytics which automatically analyze the resource data 308. These analytics mine the resource data 308 for patterns of energy use, both at the individual (i.e. one installation) and aggregate (i.e. many installations) level. The resource manager 107, 120 also creates representational models of the resource data 308 on an hourly, daily, weekly, and yearly bases.

Alternately, the user 118 may view the resource data 308 in the user interface 300 and reach various conclusions regarding variations in the resource data 308.

Depending upon the analytics applied by the resource manager 107, 120 and the user 118, explanations for certain change-points, trends, missing data, patterns, anomalies, or other variations in the resource data 308 may be useful for better managing the resources 104. Such variations can be caused: when the user 118 replaces a refrigerator with a more energy efficient model resulting in a drop in electric power consumption; or when the user 118 installs a backyard lighting system, resulting in an increased power consumption (but only at night); or when the user 118 goes on a vacation for a week resulting in an electric power reduction. Other variations in the resource data 308 may be caused: when a TV is turned on; when in-laws visit; by a kitchen cooking fest, or when new energy efficient lighting is installed.

In order to capture the event or user 118 behavior which caused the variations in the electric resource data 308, and to capture any other interesting and/or ambiguous resource data 308 variations, the resource manager 107, 120 can automatically generate and display annotation requests 314, on the user interface 300, proximate to a region of the resource data 308 curve which displays the interesting and/or ambiguous electrical resource data variation. The resource manager 107, 120 can also generate and display its own resource manager annotations 315 on the resource data 308 curve.

The resource manager 107, 120 may add these annotation requests 314 and resource manager annotations 315 on the basis of the resource manager's 107, 120 own built-in analytics, or based on specific or aggregated feedback and tips (Note: a “tip” is a type of annotation) from users 118 at the other installations 103. In fact, community feedback and tips from other installations 103 may be a significant source of resource manager annotations 315 if there is a significant similarity between the resources and devices at both the installation 102 and the other installations 101. Often the collective wisdom of a community of resource managing installations can be as, if not more, insightful than many programmed analytical resource management tools.

The user 118 at the installation 102 can also flag regions of the resource data 308 curve and add their own user annotation 316 to explain, or hypothesize an explanation, why a variation in the resource data 308 occurred. User 118 generated annotations can also become “tips” which are transmitted to the network resource manager 107, and thereby broadcast to and used by the other installations 103 for their own resource usage and/or generation annotations.

The user 118 can also contradict or disagree with the resource manager annotation 315 added by the resource manager's 107, 120 own built-in analytics, or based on specific or aggregated feedback and tips from users 118 at the other installations 103. Sometimes the analytical tools and community tips are wrong.

The user 118, at the installation or one of the other installations 103, responds to the annotation request 314 or adds their own user annotation 316 using an annotation dialog window 318. Information can be entered into the dialog window 318 as either “structured information” (e.g. a pull down menu with pre-populated selections) or as “unstructured information” (e.g. free form comments and remarks). In FIG. 3, an example set of “structure information” selections includes: “Turning an existing device on or off”, “A one-time event”, “Ongoing change in use”, “Adding/removing/upgrading a device”, and “Other/I'm not sure”. However, the annotations can take many different forms as well, including: occupancy based annotations (e.g. “one-time events” such as a specific vacation, business trip, or visit); behavior-change based annotations (e.g. took shorter showers, turned computer off at night, lowered the thermostat, turned TV off when not watching, changed to energy efficient lighting changed to energy efficient appliances, do laundry at night); and devices based annotations (e.g. device on; device off; adding device; remove device; upgrade device; holiday lights).

The user 118 and network manager 107, 120 can generate anticipated and aspirational annotations as well at future dates (i.e. before actual resource data 308 has even been collected). For example, the user 118 may specify a future action, to be taken, which the user 118 thinks may result in future energy savings or better energy generation.

These aspirational annotations can also providing an opportunity for the network manager 107, 120 to measure, validate, and quantify actual energy savings achieved, and verify if user's 118 resource prediction was correct.

Thus the present invention's annotation functionality helps both the user 118 and the network manager 107, 120 associate and link detected resource variations with events and actions within the installation 102.

The network manager 107, 120 can also use its internal analytics in conjunction with the collective “annotations” received from both the user 118 and the other installations 103 to disaggregate the resource usage of multiple devices which are being monitored by a common sensor.

Some examples of such aggregately monitored devices include: devices 128 and 130 commonly monitored by sensor 126; devices 130 and 134 commonly monitored by sensor 132; the FIG. 2 power strip collecting a common set of Current (A) sensor data 208 from: a lamp and a fan; and the FIG. 2 lights sensor 206 collecting a common set of Current (A) sensor data 208 from: a filament light bulb; an LED array; a CFL (compact fluorescent light); and one or more halogen lights.

The user interface 400 of FIG. 4, presents an example graph of composite resource usage 402 verses time 404, commonly monitored by sensor. The resource usage 402 in this example is collected from a single Current(Amps) sensor monitoring a power strip (not shown). Initially the single Current sensor only sees the “outline” of the Current(A) consumption (i.e. resource usage 402) which has been idealized to a series of step regions for illustrative purposes.

Based just on an “outline” of the Current(A) consumption alone, the resource manager 107, 120 might not be able to disambiguate the fan device 406, the lamp device 408, the TV device 410, and the TV device baseline usage 412, each drawing Current(A) from the power strip. However, the resource manager 107, 120 can generate “annotation requests” at each of the times 414 though 440. If the user 118 responds to these “annotation requests” (e.g. 314), the resource manager 107, 120 will collect and analyze the user's 118 annotation responses, entered through their corresponding “annotation dialog window” (e.g. 318). Some example user annotations are as follows:

Time 414—Fan ON;

Time 416—Lamp ON;

Time 418—Lamp OFF;

Time 420—Lamp & TV ON;

Time 422—TV OFF;

Time 424—Lamp & Fan OFF;

Time 426—TV ON;

Time 428—TV OFF;

Time 430—Fan, Lamp, & TV ON;

Time 432—Lamp & TV OFF;

Time 434—TV ON;

Time 436—TV OFF;

Time 438—Fan OFF;

Time 440—UnPlug TV;

Given these example user “ON-OFF” annotations and the Current(A) consumption data from the power strip, the resource manager 107, 120 would be able to disambiguate the fan device 406, the lamp device 408, the TV device 410, and even the TV device baseline usage 412 (due to the “Time 440—UnPlug TV” annotation). Note, these annotations could also have included device MODE changes, such as STANDBY, LOW POWER, HIGH POWER, and various other power states juxtaposed between ON and OFF.

In other example embodiments, the resource manager 107, 120 can include predefined “disambiguation models” for various devices, which could analyze the installation's 102 resource usage and generation “patterns” from individual sensors to automatically disaggregate a set of devices connected to that sensor. Thus, using user, community, and model annotations, the system 100 can detect “device specific” usage patterns and associate resource usage “per device”, as opposed to “per zone”, even if only one sensor (e.g. Smartplug) collects data for all the devices.

In one embodiment, this “one sensor” could be a single “electric power meter” for an entire home. Such disambiguation techniques could thus greatly reduce the price of monitoring a home's energy usage since there is no need to purchase, install, and maintain Smartplugs and Smartappliances which may be costly to deploy in bulk. This cost savings applies to the other sensors (e.g. water, gas, bandwidth, etc.) as well.

Once the resource manager 107, 120 has collected “annotations”, and performed any necessary sensor/device “disattibiguations”, the resource manager 107, 120 can generate one or more “notifications”, “Notifications” are herein defined broadly to include: community tips, action requests, task assignments, voluntary user actions, remediation requests, rewards, badges, certifications, warnings, penalties, device control signals, and so on. In one example, the resource manager 107, 120 could present users 118 with “actionable insights and options” to help the user 118 either reduce their resource consumption or enhance their resource production. For instance, by comparing a devices energy profile against current “Best-In-Class” device performance data, the resource manager 107, 120 can present a customized ROI (Return On Investment) plan of action to the user 118, thereby encouraging replacement of an energy wasting device.

Notifications can also be thematically driven according to a given resource model. Some example “resource models” include: Minimizing Individual Home Energy Consumption; Maximizing Utility Energy Production; Minimizing Community Home Energy Consumption; Increasing Inter-Community Sharing of Energy Saving Tips; Identifying Activity Profiles for Selected Devices (e.g. a gaming system, to enable better parental monitoring); and so on. Each of these notifications can help engage the user 118, driving resource awareness, and yielding better resource management practices, and all levels in the supply chain.

Once a set of notifications have been generated, the resource manager 107, 120 can later verify (i.e. validate) the resultant user's 118 device and/or behavioral changes (e.g. refrigerator energy usage decreased alter user replaced refrigeration with a “Best-In-Class” model, as recommended).

The resource manager 107, 120 can also use the user's 118 feedback after following the notification's instructions, to validate the accuracy and effectiveness of the notifications themselves. The installation 102 community can also vote on the usefulness and value of the notifications. Over time, any ineffective or off-point notifications will be rewritten, updated, or otherwise improved upon.

As an additional incentive for encouraging an engaged set of users 118 who participate in or generate a robust dialog, tips, and other notifications, the system 100 can include a rewards methodology, including points, badges, certifications, coupons, discounts, responsibilities, etc. These rewards can be granted at any point in the system's 100 construction or operation, including when users 118: install the system 100 at their installation; build their installation profile (e.g. zones, sensors, and devices); annotate the resource data (e.g. 308) from their installation 102, or other installations 103; post valuable energy saving tips; and/or test-out (i.e. validate) energy saving community suggestions. In one embodiment, the rewards can be incorporated into a “gaming environment”.

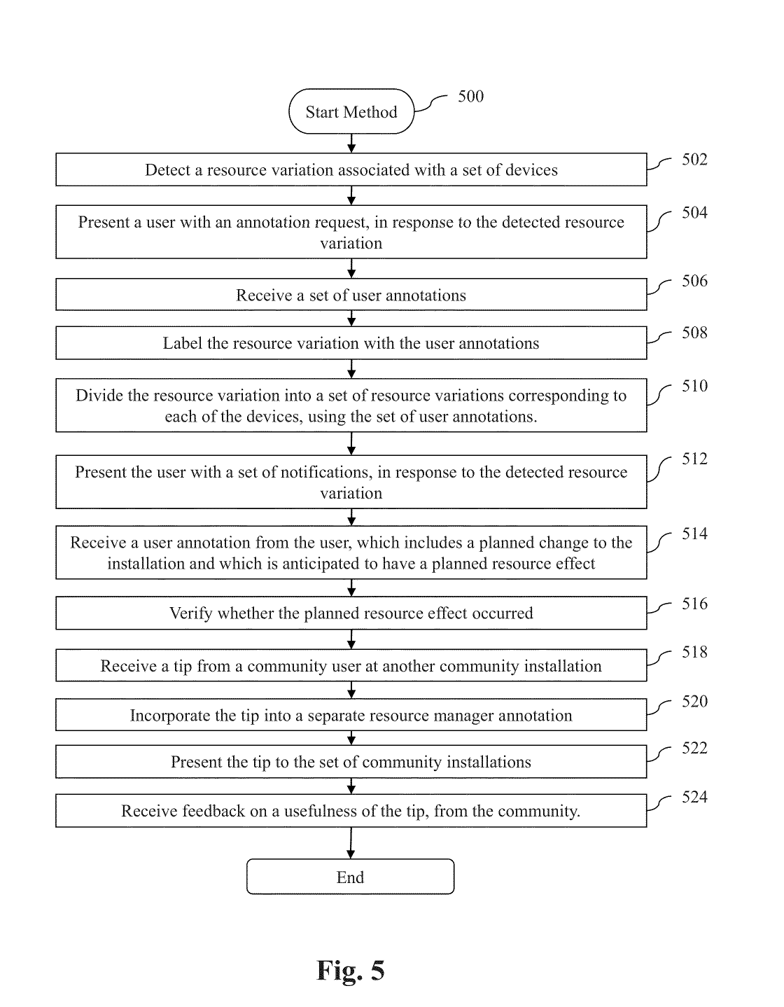

FIG. 5 is a flowchart of one example of a method 500 for annotating resource variations. The blocks comprising the flowchart can be effected in any order, unless a specific order is explicitly stated. Also, those skilled in the art will recognize that while one example of the present invention's method is now discussed, the material in this specification can be combined in a variety of ways to yield other examples as well. The method next discussed is to be understood within a context provided by this and other portions of this detailed description.

The method 500 begins in block 502, where a resource 104 variation 308 associated with a set of devices 128 is detected. Next in block 504, the user is presented with an annotation request 314, in response to the detected resource variation. Then in block 506, a set of user annotations 316 are received in response to the annotation request 314. In block 508, the resource variation is labeled with the user annotations 316. Then in block 510, the resource variation are divided into a set of resource variations corresponding to each of the devices, using the set of user annotations. Next in block 512, the user is presented with a set of notifications, in response to the detected resource variation 308. In block 514, a user annotation 316 is received from the user, which includes a planned change to the installation 102 and which is anticipated to have a planned effect on the detected resource variation 308. Then in block 516, whether the planned effect occurred is verified. Next in block 518, a tip 316 is received from a community user at another community installation 103, in response to the annotation request 314. Then in block 520, the tip is incorporated into a separate resource manager annotation 315, generated by the network resource manager 107 in response to the annotation request 314. In block 522, the tip is presented to the set of community installations. Then in block 524, receiving feedback on a usefulness of the tip, from the community.

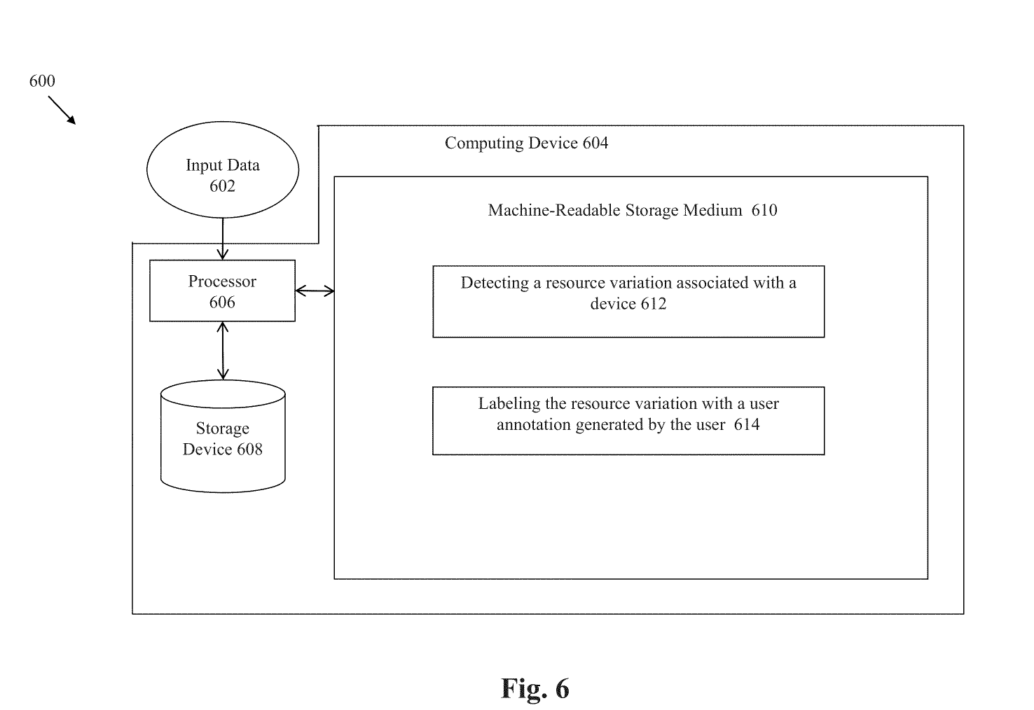

FIG. 6 is another example 600 of the system 100 for annotating resource variations. The diagram 600 shows input data 602 being received by a computing device 604. The computing device 604 includes a processor 606, a storage device 608, and a machine-readable storage medium 610. Instructions within the machine-readable storage medium 610 control how the processor 606 interprets and transforms the input data 602, using data within the storage device 608.

The instructions stored in the machine-readable storage medium 610 include: block 612, detecting a resource 104 variation 308 associated with the device 128; and block 614, labeling the resource variation with a user annotation 316 generated by the user 118.

The processor (such as a central processing unit, CPU, microprocessor, application-specific integrated circuit (ASIC), etc.) controls the overall operation of the storage device (such as random access memory (RAM) for temporary data storage, read only memory (ROM) for permanent data storage, firmware, flash memory, external and internal hard-disk drives, and the like). The processor device communicates with the storage device and machine-readable storage medium using a bus and performs operations and tasks that implement one or more blocks stored in the machine-readable storage medium.

As Used Herein and in the Claims, these Words are Further Defined as Follows:

The term “cloud” is a computer network accessible over the internet and/or web that is dynamically scalable with virtualized resources, such as printing resources. Users are not required to have knowledge or expertise in the infrastructure of the cloud that relies on the internet to satisfy the computing or (printing needs of users. The cloud provides computer and/or printing device services with business applications that are accessible from a web browser while software and data are stored on servers in the cloud. For example, a printing cloud system supports infrastructure for printing device services, platform for the printing device services, and software for the printing device services.

The term “file” or “a set of files” refers to any collection of files, such as a directory of files. A “file” can refer to any data object (e.g., a document, a bitmap, an image, an audio clip, a video clip, software source code, software executable code, etc.). A “file” can also refer to a directory (a structure that contains other files).

Functional and software instructions described above are typically embodied as a set of executable instructions which are effected on a computer which is programmed with and controlled by said executable instructions. Such instructions are loaded for execution on a processor (such as one or more CPUs). The processor includes microprocessors, microcontrollers, processor modules or subsystems (including one or more microprocessors or microcontrollers), or other control or computing devices. A “processor” can refer to a single component or to plural components.

In one example, one or more blocks or steps discussed herein are automated. In other words, apparatus, systems, and methods occur automatically. The terms “automated” or “automatically” (and like variations thereof) mean controlled operation of an apparatus, system, and/or process using computers and/or mechanical/electrical devices without the necessity of human intervention, observation, effort and/or decision.

In some examples, the methods illustrated herein and data and instructions associated therewith are stored in respective storage devices, which are implemented as one or more computer-readable or computer-usable storage media or mediums. The storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; and optical media such as Compact Disks (CDs) or Digital Versatile Disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of examples, those skilled in the art will appreciate numerous modifications and variations thereof. It is intended that the following claims cover such modifications and variations as fall within the true spirit and scope of the invention.

What is claimed is:

1. A system, comprising:
an installation 102, having a device 128 associated with a user 118; and
a resource manager 107, 120 programmed with executable instructions, including:
detecting a resource 104 variation 308 associated with the device 128; and
labeling the resource variation with a user annotation 316 generated by the user.

2. The system of claim 1:
further comprising another installation 103, which forms a community with the installation 102, and includes another community user; and
wherein the resource manager further includes instructions for:
incorporating another user annotation generated by the another community user into the annotation 315, 316; and
labeling the resource variation with the annotation 315, 316.

3. The system of claim 1, wherein the resource variation comprises at least one from a group including:
resource usage, resource generation, and resource recycling.

4. The system of claim 3, wherein the resource 104 comprises at least one from a group including:
electricity 108, water 110, gas 112, telecommunication 114, network bandwidth 116, use of network bandwidth 116, cloud services resources 116, and other resources 116.

5. The system of claim 4, wherein the installation 102 comprises at least one from a group including:
a home, a business, a city, a utility, a production line, a smart-grid, a region, a transmission line, and a recycling facility.

6. The system of claim 1,
wherein the installation further includes a sensor 126;
wherein the instructions further include detecting the resource variation with the sensor; and
wherein the sensor comprises at least one from a group including: an electric sensor, a water sensor, a gas sensor, a data sensor, a network sensor, a volume sensor, a weight sensor, a temperature sensor, a chemical sensor, and a biological sensor.

7. A system, comprising:
a network resource manager service 107 programmed with executable instructions, including:
interfacing with an installation 102, having a set of sensors 126 and a set of devices 128 associated with a user 118;
receiving data from at least one of the sensors which detects a resource 104 variation 308 associated with at least one of the devices; and
labeling the detected resource variation with a user annotation 316.

8. The system of claim 7, wherein the detected resource variation is at least one from a group including:
a change-point, a trend, missing data, a pattern, and an anomaly.

9. The system of claim 7, wherein the user annotation is at least one from a group including:
a device replacement annotation, a device failure annotation, a device state change annotation, a user behavior annotation, and an installation state change annotation.

10. The system of claim 7, wherein the resource manager further includes instructions for:
presenting the user with an annotation request 314, in response to the detected resource variation; and
receiving the user annotation 316, in response to the annotation request 314.

11. The system of claim 10:
further comprising another installation 103, which forms a community with the installation 102, and which is associated with another community user; and
wherein the resource manager further includes instructions for:
receiving a tip 316 from the community user, in response to the annotation request 314; and
incorporating the tip into a resource manager annotation 315 which is generated by the network resource manager 107 in response to the annotation request 314.

12. The system of claim 11, wherein the resource manager further includes instructions for:
presenting the tip to a set of community installations; and
receiving feedback on a usefulness of the tip, from the community.

13. The system of claim 7, wherein the resource manager further includes instructions for:
receiving a user annotation 316 from the user, which includes a planned change to the installation 102, having a planned effect on the detected resource variation 308; and
verifying whether the planned effect occurred.

14. The system of claim 7, wherein the resource manager further includes instructions for:
presenting the user with a notification, in response to the detected resource variation 308, wherein the notification includes at least one from a group including: a community tip, an action request, a task assignment, a voluntary user action, a remediation request, a reward, a badge, a certification, a warning, a penalty, a device control signal.

15. An article comprising at least one computer-readable storage medium storing instructions that upon execution cause a computer system to:
detect a resource 104 variation 308 associated with a set of device 128 associated with a user 118;
label the resource variation with a set of user annotations 316 generated by the user; and
divide the resource variation into a set of resource variations corresponding to each of the devices, using the set of user annotations.

16. The article of claim 15, wherein set of user annotations includes:
a set of device state changes, including at least one from a group including: device ON, device OFF, and device MODE.
